(19) United States
(12) Patent Application Publication
(10) Pub. No.: US 2007/0177281 A1
(43) Pub. Date: Aug. 2, 2007

(54) Assembly including an optical lens and a support, and method using them

(76) Inventors: Daniel Darmes, Charenton Le Pont (FR); Yohann Felten, Charenton Le Pont (FR); Matthieu Koscher, Charenton Le Pont (FR); Dominique Rychel, Charenton Le Pont (FR)

Correspondence Address: YOUNG & THOMPSON, 745 SOUTH 23RD STREET, 2ND FLOOR, ARLINGTON, VA, 22202, US

(21) Appl. No.: 11/643,899

(22) Filed: Dec. 22, 2006

(30) Foreign Application Priority Data
Dec. 23, 2005 (FR) 0513267

(51) Int. Cl. G02B 7/02

(52) U.S. Cl. 359/811

(57) ABSTRACT

The optical lens (1) includes a circular edge (2) in which is made a notch (3) whereby the lens (1) may be held by at least a portion of its edge (2) and angularly indexed by the notch (3) vis à vis the support.

The invention concerns the field of the fabrication of optical lenses.

The invention concerns more particularly methods and devices for processing an optical lens in order to confer upon it the required properties.

Such processing may for example consist in depositing a surface coating onto the faces of an ophthalmic lens to confer upon it particular mechanical or optical properties.

There is known from the document WO 00/14295 a support for optical lenses and its method of use for holding an optical lens in processing apparatus of the “spin coating” type. That support includes a base on which are mounted three bearing studs for holding the optical lens by its edge.

The aim of the invention is to improve this type of prior art devices and methods.

To this end, the invention is aimed at an assembly including an optical lens as described hereinabove and a support on which said optical lens is mounted, the support including at least three studs for holding the optical lens by its edge, characterized in that the lens includes a circular edge in which a single notch is made and in that it is held by the cooperation of its edge with the three studs of the support and angularly indexed by the engagement of one of the studs of the support in the notch.

According to another object, the invention is aimed at a method of processing an optical lens, characterized in that:
a processing station is used having a particular processing direction;
it is on an optical lens produced beforehand and belonging to an assembly as described hereinabove that said processing is effected; and
the processing includes a step of angular orientation of the optical lens by holding the optical lens by its edge and angular indexing by the notch of the optical lens in order to make the straight line segment substantially connecting the center of the optical lens to the notch coincide with said particular processing direction.

The invention uses an indexing system for defining an axis specific to the processed optical lens. The optical lens may therefore be oriented angularly during a processing step, it being understood that, in the sense of the invention, processing comprises a plurality of steps including, for example, a step of deposition of a coating, a step of structuring, of orientation or of polymerization of said coating.

When an operation conferring upon an optical lens particular properties in a given direction is carried out on a fabrication station, the invention enables the lens to be moved, even the fabrication station to be changed, retaining the possibility of returning to said particular direction at any time. This is particularly beneficial when the processing comprises the deposition of a polarizing coating. In fact, it is indispensable to be able to identify the polarization axis on the optical lens until its production is finished.

The invention is therefore particularly suitable for the successive deposition of different anisotropic coatings and orienting those coatings relative to each other, thanks to this angular indexing, even if the successive coatings take place at different fabrication stations involving a movement of the optical lens and therefore a loss of angular orientation.

For example, it is possible thanks to the invention to use a method whereby a first coating is deposited in the liquid state onto one face of an optical lens, that coating then undergoing polymerization by ultraviolet rays passing through a polarizer so that the first coating obtained features a structuring of its molecules in accordance with a direction determined by the polarizer. A second coating is then deposited onto the first, then polymerized.

According to preferred features of the optical lens belonging to the assembly:
the notch has a U-shaped profile;
the notch has a circular arc profile;
the diameter of the circular portions of the profile of the notch is approximately 0.5 to 5 mm;
the diameter of the circular portions of the profile of the notch is approximately 1 to 3 mm;
the diameter of the circular portions of the profile of the notch is approximately 1.5 mm.

According to preferred features of the support belonging to the assembly:
the support further includes mounting means adapted to cooperate with receiving means of a processing station;
the support further includes angular indexing means;
said mounting means include a ring upstanding from or recessed into the support, preferably upstanding therefrom, and said angular indexing means include a first cut-out made in the ring;
the angular indexing means include a second cut-out made in the ring and diametrally opposite the first cut-out;
the ring includes an engagement chamfer;
each of the studs includes a frustoconical bottom portion surmounted by a finger, one of the fingers being engaged in the notch, the optical lens bearing on the summit of the frustoconical bottom portion, at the level of its junction with the finger;
the angle formed between the slope of the frustoconical bottom portion and the support is less than 85°;
said angle is between 30 and 60°;
said angle is substantially equal to 45°;
the diameter of the finger substantially corresponds to the dimensions of the notch;
the stud that is engaged in the notch includes marking means distinguishing it from the other studs;
the distance between each of the studs and the center of the support is between 97% and 100% of the radius of the optical lens.

Other features and advantages of the invention become apparent in the light of the following description of a preferred embodiment, given by way of nonlimiting example, description given with reference to the appended drawings in which:

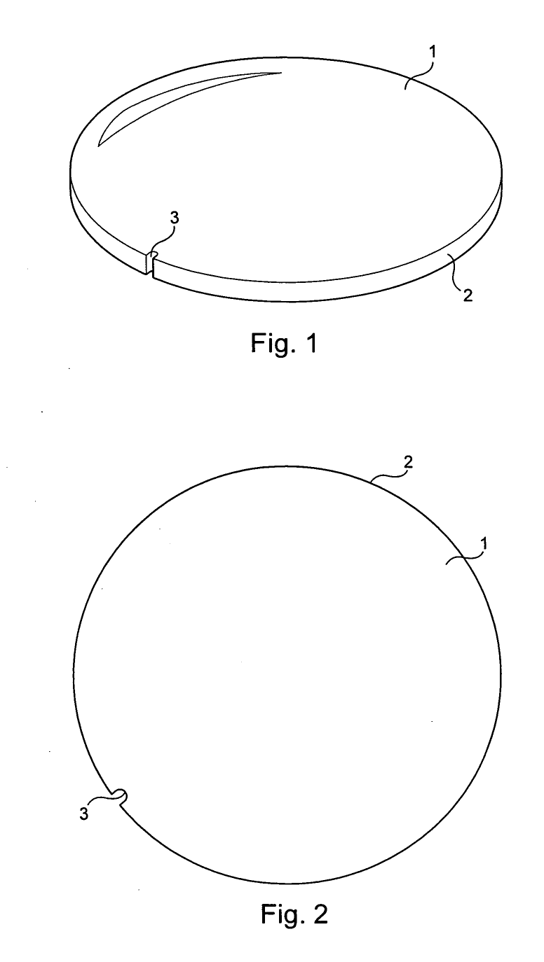

FIG. 1 represents in perspective an optical lens according to the invention;

FIG. 2 is a view from above of the lens represented in FIG. 1;

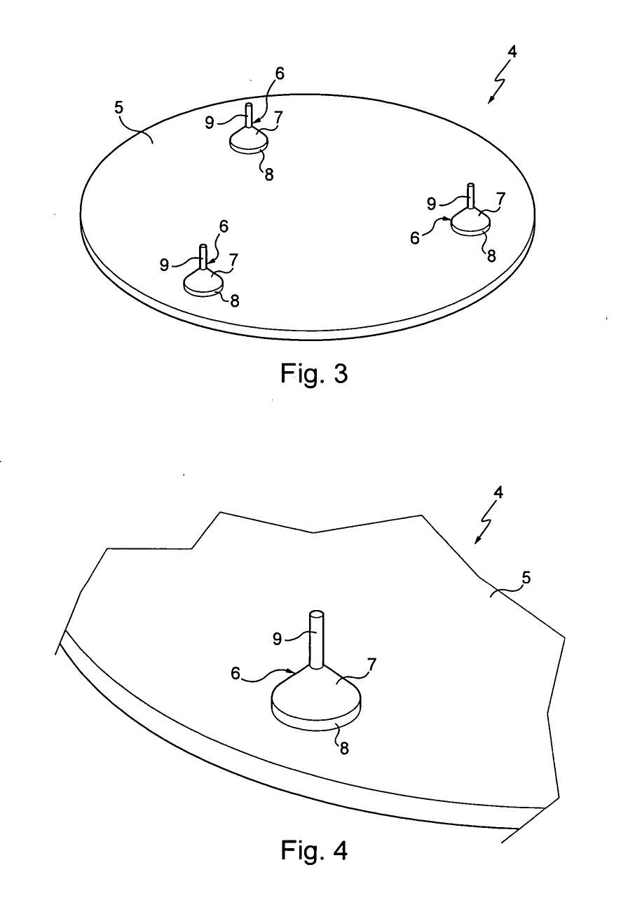

FIG. 3 represents in perspective a support adapted to receive the optical lens from FIGS. 1 and 2;

FIG. 4 is a partial view to a larger scale of the support represented in FIG. 3;

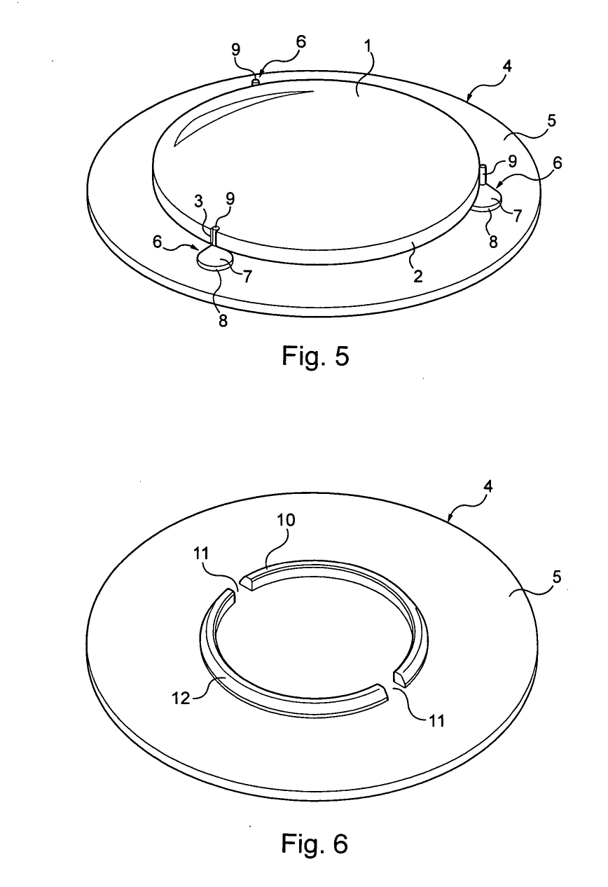

FIG. 5 represents in perspective an assembly according to the invention including the lens from FIGS. 1 and 2 mounted on the support from FIGS. 3 and 4;

FIG. 6 represents in perspective the support from FIG. 3 in an overturned position.

FIG. 1 shows an optical lens 1 which, in the present example, is an ophthalmic lens employed in the production of a pair of eyeglasses. In the sense of the invention, ophthalmic lenses means lenses fitting in particular into an eyeglass frame or a visor support, having the function of protecting the eye and/or correcting the sight, these lenses being chosen from afocal, unifocal, bifocal, trifocal and progressive lenses. These ophthalmic lenses may comprise an organic or mineral substrate. Substrate means the transparent basic constituent material of the ophthalmic lens. This material serves as a support for stacking one or more coatings comprising in particular polarizing coatings. This lens 1 is first produced in the conventional way by molding and/or machining in order to obtain a lens of circular shape having a concave face and a convex face and having the required optical characteristics.

The lens 1 is destined to undergo a certain number of processing operations including surface coatings applied to one or each of its faces, then to be trimmed thereafter, i.e. machined from its edge, in order for its contour to correspond to the contour of the rims of the eyeglass frame in which the lens 1 may be destined to be mounted.

The lens 1 from FIG. 1 includes an edge 2 that is circular (see view from above in FIG. 2).

A notch 3 is made on the edge 2 of the lens 1.

The notch 3 has a U-shaped profile and extends over the whole height of the edge 2.

The notch 3 may be produced by machining a circular contour lens or directly when molding the lens 1.

FIG. 3 represents in perspective a support 4 destined to hold the lens 1 and to position it with a view to its processing.

The support 4 includes a base 5 preferably having the shape of a disc the diameter whereof is greater than the diameter of the lens 1 destined to be supported.

The support 4 further includes three studs 6 mounted on the base 5. The three studs 6 are preferably positioned equidistantly relative to the center of the base 5 so that the support 4 has an angle of 120° between each stud 6 measured at the center of the base 5.

The studs 6 are preferably equidistant from the center of the base 5. The distance between each stud and the center of the base 5 is preferably at least equal to 97% of the radius of the lens 1 destined to be held and is preferably less than 100% of said radius.

FIG. 4 shows one of the studs 6 to a larger scale.

Each of these studs 6 includes a frustoconical bottom portion 7 fixed to the base 5 by a cylindrical portion 8.

The frustoconical bottom portion 7 is extended by a finger 9 extending perpendicularly to the base 5.

The cylindrical portion 8 may have a diameter between 2 mm and 10 mm, preferably between 4 mm and 8 mm.

The height of the cylindrical portion 8 is chosen as a function of the convex or concave shape of the lens, its radius of curvature and the dimensions of the lens 1. That height is advantageously such that the lens is situated as close as possible to the base without touching the latter, however. Accordingly, in the case of a convex lens, the height of the cylindrical portion 8 is advantageously between 0.5 mm and 8 mm, preferably less than 5 mm. In the case of a concave lens, this height is advantageously between 2 mm and 10 mm, preferably between 5 mm and 8 mm.

With reference to the slope of the frustoconical bottom portion 7, the angle between a generatrix of the frustoconical bottom portion 7 and the base 5 is advantageously less than 85° and preferably between 30° and 60°. In the present preferred example this angle is 45°.

The finger 9 advantageously has a diameter between 0.5 mm and 5 mm and preferably between 1 mm and 3 mm.

The finger 9 is destined to come up against the edge 2 of the lens 1 to retain it laterally whereas the summit of the frustoconical bottom portion 7, which creates a step at bottom of the finger 9, is destined to provide a vertical seating for the lens 1.

FIG. 5 shows the lens 1 held and positioned in the support 4.

The lens 1 rests on three bearing points each consisting of the summit of a frustoconical bottom portion 7 whereas the fingers 9 come up against the edge 2 of the lens 1.

At the level of the notch 3, the edge 2 follows the depression delimited by this notch 3 in which one of the studs 6 goes and bears against the bottom of the depression.

The distance between each of the studs 6 and the center of the base 5 is chosen so that, when the fingers 9 are in contact with the edge 2 of the lens 1, the lens 1 is substantially centered between the three studs 6.

According to the material employed for the production of the support 4, a certain flexibility of the fingers 9 may be exploited to hold the lens 1 firmly.

The finger 9 that is engaged in the notch 3 provides angular indexing of the lens 1. If the lens 1 is separated from the support 4 and then mounted on the support 4 again, the lens 1 may return to the same angular position relative to the support 4 as at the time of the first mounting, preferably engaging the same finger 9 in the notch 3 as at the time of the first mounting.

One of the studs 6 may advantageously be identified by a color or a sign as being the particular stud 6 over which the notch 3 should always be engaged.

The shape and the dimensions of the notch 3 and the dimensions of the finger 9 are advantageously chosen so that, when the finger 9 is engaged in the notch 3, this engagement is effected with no angular play so that the lens 1 is locked against rotating on the support 4.

The assembly from FIG. 5 may, for example, be mounted in an equipment adapted to deposit a coating onto the external face of the lens 1. In this case, each of the studs 6 provides a point seating for the lens 1, at the level of the contact between the summit of the frustoconical bottom portion 7 and the bottom of the edge 2. This point contact avoids the conventional defects that occur on application of a fluid coating.

In fact, when the fluid coating is deposited onto the external face of the lens 1, a portion of that coating tends to flow along the edge 2 and then to come into contact with the studs 6. If the fluid coating that has flowed onto the studs 6 is able to accumulate at this point, defects are produced and may be carried over to the lower face of the lens 1, i.e. the face on the same side as the base 5. Thanks to the frustoconical bottom portion 7 enabling the point contact, the coating has no surface on which it can accumulate. Moreover, the surface of the frustoconical bottom portion 7 provides for the coating an evacuation ramp extending 360° around the finger 9, enabling the surplus coating at the level of the fingers 9 to be transferred towards the base 5 of the support and removed from the lens 1.

FIG. 6 shows the underside of the support 4. The lower face of the base 5, i.e. that opposite the face carrying the studs 6, thus includes a second angular indexing device formed of a ring 10 projecting from the base 5 and including two diametrally opposed cut-outs 11.

The ring 10 includes a chamfer 12 to facilitate fitting this ring 10 to appropriate equipment.

The ring 10 is in fact used to mount the support 4 on the receiving means of an equipment (not shown) destined to process the lens 1. In the case of the ring 10 of the present example, these receiving means may be formed of a cylindrical orifice having a diameter adjusted to the outside diameter of the ring 10, and two projecting tongues adjusted to the width of the cut-outs 11 so that the ring 10 may be engaged in these receiving means and indexed angularly. The support 4 may be held in these receiving means by a suction device or any other known means.

The ring 10 on the one hand and the cooperation of the notch 3 with one of the studs 6 on the other hand form a double angular indexing system for angularly orienting the lens 1 on the support 4 and orienting the support 4 relative to an equipment, which amounts to angularly orienting the lens 1 relative to an equipment and being able to return to this angular orientation afterwards.

The angular indexing provided by the ring 10 of the present example provides angular indexing of the support 4 to within 180° because of the presence of two cut-outs 11. This angular indexing suffices if it is a question simply of identifying a direction on the lens 1, that direction being the same to within a half-turn.

Alternatively, the ring 1 may include a single cut-out 11, thus procuring a unique angular indexing.

Thanks to this two-fold angular indexing, the following method may be used, for example.

The lens 1 is first mounted on the support 4, one of the fingers 9 engaging in the notch 3. The support 4 is then placed in position on a coating machine that effects the deposition of a fluid coating onto the surface of the lens 1.

The support 4 is then separated from the coating machine and is disposed in the receiving means of an ultraviolet oven comprising tongues cooperating with the cut-outs 11 and equipped with a polarizer so that the coating deposited on the lens 1 is polymerized and structured in a direction determined by the orientation of the polarizer. That direction defines the axis of orientation of the polarization of the lens that it is necessary to know until the lens is mounted in the eyeglass frame, for example in order to guarantee the polarizing function in the finished object.

The support 4 is then placed in position in a second coating machine depositing a second fluid coating on the first coating that has been hardened by the polymerization.

The support 4 is again placed in the receiving means of an ultraviolet ray oven equipped with tongues inserted in the cut-outs 11.

These various means are particularly well adapted, in particular for the processing of an ophthalmic lens by a two-layer polarizing coating as described in the patent application EP 1 593 990.

Different embodiments of the support and the optical lens described may be envisaged without departing from the scope of the invention. In particular, these elements may use any method other than that described by way of example.

Similarly, the studs 6 may have no frustoconical bottom portion 7, the bottom portion then being formed directly by the cylindrical portion 8 which then forms a shoulder at the bottom of the finger 9, that shoulder constituting the seating of the lens. The support 4 may be made in one piece, for example in a polymer that can be injection molded or an appropriate metal alloy.

The notch 3 may have a circular arc profile or any other profile.

Alternatively, the support 4 may include a central sucker instead of and in place of the studs 6 for holding the optical lens by suction on its lower face.

1. Assembly including an optical lens (1) and a support (4) on which said optical lens (1) is mounted, the support (4) including at least three studs (6) for holding the optical lens (1) by its edge (2), characterized in that the lens includes a circular edge (2) in which a single notch (3) is made and in that it is centered by the cooperation of its edge (2) with the three studs (6) of the support (4) and angularly indexed by the engagement of one of the studs (6) of the support in the notch (3).

2. Assembly according to claim 1, characterized in that the notch (3) has a U-shaped profile.

3. Assembly according to claim 1, characterized in that the notch (3) has a circular arc profile.

4. Assembly according to claim 1, characterized in that the diameter of the circular portions of the profile of the notch (3) is approximately 0.5 to 5 mm.

5. Assembly according to claim 1, characterized in that the diameter of the circular portions of the profile of the notch (3) is approximately 1 to 3 mm.

6. Assembly according to claim 1, characterized in that the diameter of the circular portions of the profile of the notch (3) is approximately 1.5 mm.

7. Assembly according to claim 1, characterized in that the support (4) further includes mounting means (10) adapted to cooperate with receiving means of a processing station.

8. Assembly according to claim 7, characterized in that the support (4) further includes angular indexing means (11).

9. Assembly according to claim 8, characterized in that said mounting means include a ring (10) upstanding from or recessed into the support (4) and in that said angular indexing means include a first cut-out (11) made in the ring (10).

10. Assembly according to claim 9, characterized in that the angular indexing means include a second cut-out (11) made in the ring (10) and diametrally opposite the first cut-out (11).

11. Assembly according to claim 9, characterized in that the ring (10) includes an engagement chamfer (12).

12. Assembly according to claim 1, characterized in that each of the studs (6) includes a frustoconical bottom portion (7) surmounted by a finger (9), one of the fingers being engaged in the notch (3), the optical lens (1) bearing on the summit of the frustoconical bottom portion (7), at the level of its junction with the finger (9).

13. Assembly according to claim 12, characterized in that the angle formed between the slope of the frustoconical bottom portion and the support (4) is less than 85°.

14. Assembly according to claim 13, characterized in that said angle is between 30 and 60°.

15. Assembly according to either of claims 13 and 14, characterized in that said angle is substantially equal to 45°.

16. Assembly according to claim 12, characterized in that the diameter of the finger (9) substantially corresponds to the dimensions of the notch (3).

17. Assembly according to claim 1, characterized in that the stud (6) that is engaged in the notch (3) includes marking means distinguishing it from the other studs (6).

18. Assembly according to claim 12, characterized in that the distance between each of the studs (6) and the center of the support (4) is between 97% and 100% of the radius of the optical lens (1).

19. Method of processing an optical lens, characterized in that:
a processing station is used having a particular processing direction;
it is on an optical lens (1) produced beforehand and belonging to an assembly according to claim 1 that said processing is effected; and
the processing includes a step of angular orientation of the optical lens (1) by holding the optical lens (1) by its edge (2) and angular indexing by the notch (3) of the optical lens (1) in order to make the straight line segment substantially connecting the center of the optical lens (1) to the notch (3) coincide with said particular processing direction.

20. Assembly according to claim 9, characterized in that the ring (10) includes an engagement chamfer (12).
